(19) United States
(12) Patent Application Publication
(10) Pub. No.: US 2008/0007753 A1
(43) Pub. Date: Jan. 10, 2008

(54) User interface for a multi-function peripheral device

(76) Inventor: Mark Van Regenmorter, Lake Forest, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/482,470

(22) Filed: Jul. 6, 2006

(51) Int. Cl. G06K 15/00

(52) U.S. Cl. 358/1.12

(57) ABSTRACT

A user interface for a multi-function peripheral device is disclosed. The user interface includes a display screen. The user interface also includes a pointing device configured to provide a signal for at least two dimensional movement on the display screen. The pointing device includes a joystick, trackball, directional pad, or motion sensor. The pointing device can be used for various functions of the MFP. The pointing device may be externally connected to the MFP via a wired or wireless connection.

### BACKGROUND OF THE INVENTION

1. Field of the Invention

The present invention relates to a multi-function peripheral device. More particularly, the present invention relates to a user interface for a multi-function peripheral device.

2. Description of the Related Technology

Recently, a multi-function peripheral device (MFP) has been widely used for its convenience and versatility. Typically, an MFP includes two or more functions of copying, scanning, printing, faxing, and emailing.

To make such functions user-accessible, an MFP includes a user interface. The user interface typically includes a control panel. The control panel may include a display screen and an input device. The display screen typically includes a liquid crystal display (LCD). The input device may include a keypad, keyboard, function keys, and/or directional buttons. Some MFPs have a touch screen serving both as a display screen and as an input device.

Since an MFP has multiple functions, user-interfacing may be complicated. In addition, a certain MFP provides features which the above-described input devices are not suitable for controlling. An exemplary feature is cropping a portion of an image displayed on the display screen. Furthermore, some MFPs have a limited space for a user interface, depending on its size and design. Therefore, there is a need to provide a simplified user interface for various functions of an MFP.

### SUMMARY OF CERTAIN INVENTIVE ASPECTS

One aspect of the invention provides a multi-function peripheral (MFP) device. The device comprises: a user interface comprising: a pointing device configured to detect at least two dimensional mechanical movement provided by a user, and configured to generate a signal corresponding to the at least two dimensional mechanical movement; and a display screen integral with the MFP device, the display screen comprising a pointer configured to move according to the signal.

The pointer may comprise a cursor. The at least two dimensional mechanical movement may comprise a two dimensional movement in a direction at an angle between 0° and 360°. The two dimensional movement may comprise a movement in a direction selected from: up, down, left, right, up-left, up-right, down-left, and down-right.

The signal may comprise data indicative of the direction of the at least two dimensional mechanical movement. The signal may comprise data indicative of the distance of the at least two dimensional mechanical movement. The user interface may further comprise one or more selection buttons. The pointing device may comprise a joystick. The pointing device may comprise a trackball. The pointing device may comprise a directional pad (D-pad).

The pointing device may be configured to select a function of the MFP device. The pointing device may be configured to scroll the display screen. The pointing device may be configured to select a target on the display screen. The target may comprise at least a portion of an image displayed on the display screen. The pointing device may be configured to adjust a parameter of the MFP device.

The pointing device may be integral with the MFP device. The pointing device may be wirelessly connected to the MFP device. The pointing device may be electrically connected to the MFP device via a port. The port may comprise a serial port, a parallel port, or a USB port.

The at least two dimensional mechanical movement may comprise a three dimensional movement. The pointing device may comprise a motion sensor. The motion sensor may comprise a gyroscope. The pointing device is configured to zoom in or out an image displayed on the display screen according to the three dimensional movement. The pointing device may be connected to the MFP device wirelessly or via a port. The MFP device may comprise two or more functions selected from: copying, faxing, scanning, printing, and emailing.

Another aspect of the invention provides a multi-function peripheral (MFP) device comprising: a display screen integral with the MFP device, the display screen comprising a pointer; means for detecting at least two dimensional mechanical movement provided by a user; means for generating a signal corresponding to the at least two dimensional mechanical movement; and means for moving the pointer on the display screen according to the signal.

Yet another aspect of the invention provides a method of user interfacing for a multi-function peripheral (MFP) device, the method comprising: providing a display screen integral with the MFP device, the display screen comprising a pointer; detecting at least two dimensional mechanical movement provided by a user; generating a signal corresponding to the at least two dimensional mechanical movement; and moving the pointer on the display screen according to the signal.

The signal may comprise data indicative of the direction of the at least two dimensional mechanical movement. The signal may comprise data indicative of the distance of the at least two dimensional mechanical movement. The at least two dimensional mechanical movement may comprise a two dimensional mechanical movement in a direction at an angle between 0° and 360°. The at least two dimensional mechanical movement may comprise a three dimensional mechanical movement.

### BRIEF DESCRIPTION OF THE DRAWINGS

FIG. 1 illustrates a schematic perspective view of a multi-function peripheral device according to one embodiment.

FIG. 2 illustrates a schematic view of an MFP user interface including a joystick in accordance with one embodiment.

FIG. 3 illustrates a schematic view of an MFP user interface including a trackball in accordance with another embodiment.

FIG. 4 illustrates a schematic view of an MFP user interface including a directional pad in accordance with another embodiment.

FIGS. 5A and 5B are schematic views illustrating user interface operations in accordance with embodiments.

FIG. 6 is a schematic view illustrating a wired connection between a pointing device and an MFP in accordance with one embodiment.

FIG. 7 is a schematic view illustrating a wireless connection between a pointing device and an MFP in accordance with another embodiment.

FIG. 8 illustrates a schematic view of an MFP user interface including a motion sensor in accordance with another embodiment.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements.

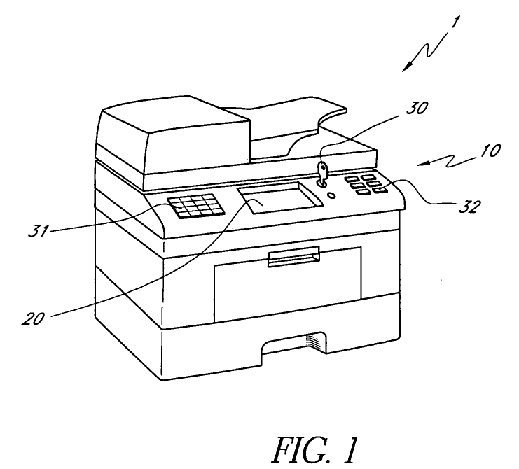

FIG. 1 illustrates a multi-function peripheral device (MFP) 1 according to one embodiment. The MFP 1 is an office machine having functions of printing, scanning, facsimile receiving and transmitting, photocopying, and emailing. The illustrated MFP 1 may include a printer, a transceiver, a scanner, a network connector, a processor and a memory. A skilled artisan will appreciate that an MFP may have more or less components and functions, depending on the design of the MFP.

In addition, the MFP 1 includes a user interface 10 to allow a user to interface with the MFP 1. The user interface 10 may include a display screen 20 and input devices. The display screen 20 may be an LCD or CRT display, for example. The illustrated display screen 20 is an LCD. The input device may include a keypad, keyboard and/or buttons. The illustrated input devices include a keypad 31 and buttons 32. In certain embodiments, the user interface 10 may include a touch screen display which functions both as a display screen and as an input device. The illustrated user interface 10 is integrated with the MFP 1. In other embodiments, the user interface may be externally connected to the MFP 1. In certain embodiments, the user interface may be a general purpose computer directly connected to the MFP 1. In other embodiments, the user interface may be a computer indirectly connected over a network to the MFP 1.

In the illustrated embodiment, the user interface 10 also includes a pointing device 30 as an input device. The pointing device 30 is configured to move a pointer on the display screen 20. The term “pointer,” as used herein, refers to any moving marker on the screen 20. Examples of the pointer include, but are not limited to, a cursor, a highlighted icon, and a selected portion of an image on the screen. In certain embodiments, the pointing device may be configured to adjust a value or number shown on the display screen 20 without involving a visual movement of a pointer.

The pointing device 30 is configured to provide a signal for a two-dimensional movement of the pointer on the display screen 20. The signal includes data indicative of a direction of the two-dimensional movement. Optionally, the signal may also include data indicative of the degree or distance of the movement. The two-dimensional movement may include a movement in one direction selected from, for example, up, down, left, right, up-left, up-right, down-left, and down-right. The movement may also be in any other direction at an angle between 0° and 360°.

The pointing device 30 may include a mechanical mechanism configured to receive a two-dimensional mechanical movement from a user. The pointing device 30 also includes a converter configured to detect the two dimensional movement and convert it into an electrical signal. The converter may be any suitable sensor which can detect a mechanical movement. In addition, the pointing device 30 may include a transmitter for providing the electrical signal to the processor of the MFP 1. In certain embodiments, the converter and the transmitter may be integrated with each other. The pointer on the display screen 20 is configured to move according to the electrical signal. Examples of pointing devices 30 include, but are not limited to, a joystick, a trackball and a directional pad (D-pad). These exemplary pointing devices are described below in detail.

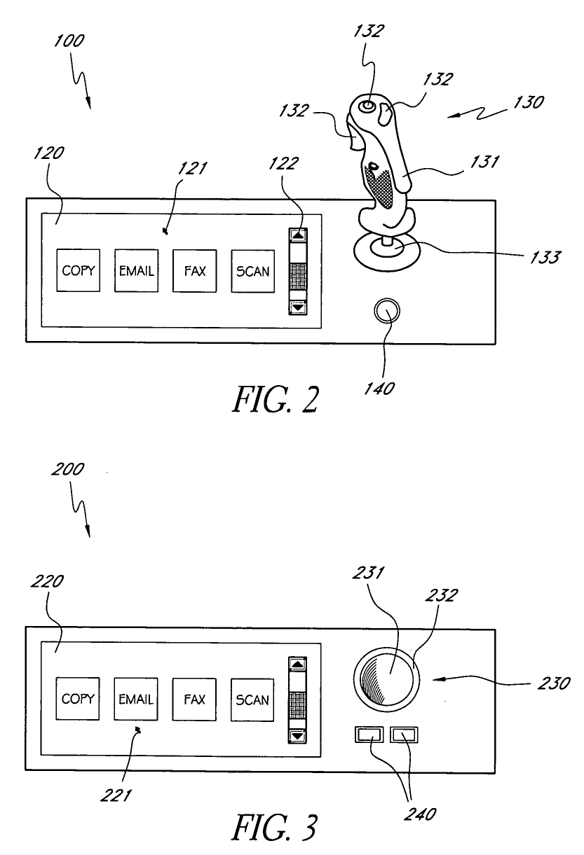

In one embodiment, the pointing device is a joystick. Referring to FIG. 2, an MFP user interface 100 includes an LCD screen 120 as a display screen and a joystick 130 as an input device.

The LCD screen 120 is any suitable type of LCD screen. The LCD screen 120 may be either a color or monochrome screen. The illustrated LCD screen 120 displays a function selection screen. The function selection screen displays icons for functions of the MFP, for example, copying, emailing, faxing, printing, and scanning. The LCD screen 120 may include a cursor 121.

The joystick 130 includes a handheld stick 131 and a base 133. The handheld stick 131 is configured to pivot about an end connected to the base 133. The movement of the stick 131 is transformed into an electrical signal representing a direction in two dimensions. In one embodiment, moving the stick 131 left or right signals a horizontal movement on the screen 120. Moving the stick 131 forward (up) or back (down) may signal a vertical movement on the screen 120. In addition, moving the stick 131 in any other desired direction signals a movement in the desired direction on the screen 120.

The joystick 130 is also provided with various buttons 132. The buttons 132 are positioned on the handheld stick 131. The buttons 132 allow a user to select a target or function when the cursor 121 has been moved to a desired position on the screen 120.

In the illustrated embodiment, the user interface 100 also includes a selection button 140 on its control panel below the joystick 130. The selection button 140 may provide the same function as the buttons 132 on the handheld stick 131. A skilled artisan will appreciate that the button configuration can be varied depending on the design of the user interface.

The joystick 130 may be either a digital or analog joystick. A digital joystick refers to a joystick which gives only on/off signals for four directions (up, down, left and right) and mechanically possible combinations (up-right, up-left, down-right, down-left, etc.). An analog joystick, on the other hand, has continuous states. The analog joystick may return an angle measure of the movement in any direction on the screen 120.

In certain embodiments, the joystick 130 may also provide a signal for a degree or distance of a movement. The joystick 130 may produce such a signal based on the extent of moving the handheld stick 131 in a certain direction.

In another embodiment, the pointing device is a trackball. Referring to FIG. 3, an MFP user interface 200 includes an LCD screen 220, a trackball 230, and selection buttons 240.

The LCD screen 220 is any suitable type of LCD screen. Similar to FIG. 2, the LCD screen 220 displays a function selection screen, showing icons for various functions of the MFP. The LCD screen 220 may also display an image to be processed, as will be better understood from later descriptions. The LCD screen 220 may include a cursor 221.

The trackball 230 is a pointing device including a ball 231 housed in a socket 232. The socket 232 contains sensors to detect the rotation of the ball about two axes. The ball 231 is configured to be rolled with the fingers or palm of a user. The sensors in the socket 232 detect the rotation of the ball and transform it into an electrical signal. The signal is transmitted to the processor of the MFP. The cursor 221 on the screen 220 moves according to the signal. A skilled artisan will appreciate that various types of trackballs can be adapted for use as an input device for an MFP.

The selection buttons 240 allow a user to select a target or function when the cursor 221 has been moved to a desired position on the screen 220. In the illustrated embodiment, the user interface 200 includes the selection buttons 240 on its control panel below the trackball 230. A skilled artisan will appreciate that the button configuration can be varied depending on the design of the user interface.

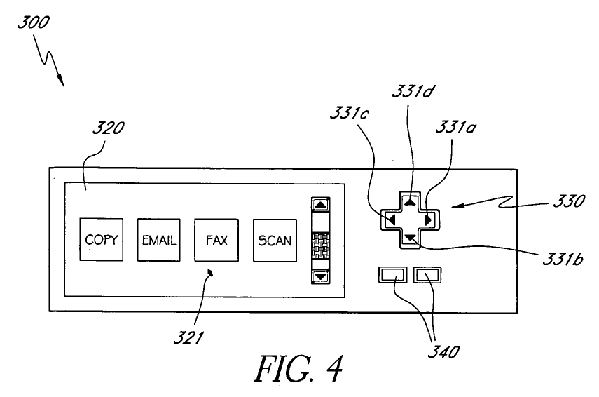

In yet another embodiment, the pointing device is a directional pad (D-pad). Referring to FIG. 4, a user interface 300 includes an LCD screen 320, a directional pad 330, and selection buttons 340. The configurations of the LCD screen 320 and the selection buttons 340 are as described above with reference to FIG. 3. The illustrated screen 320 includes a cursor 321.

In one embodiment, the D-pad 330 is a plus sign-shaped pointing device. The D-pad may have four switches 331a-331d. Each of the switches 331a-331d indicates one of four directions (up, down, left, and right). Pressing one of the switches 331a-331d moves the cursor 321 in the selected direction. In certain embodiments, the D-pad 330 may provide a diagonal movement of the cursor 321, such as up-right, up-left, down-right and down-right. Such a movement may be generated by a combination of two of the switches 331a-331d. For example, a down-right diagonal movement can be made by simultaneously pressing the right and down switches 331a and 331b. A skilled artisan will appreciate that various types of D-pads can be adapted for use as an input device for an MFP.

Exemplary functions of the pointing devices are described below in detail. Referring back to FIG. 2, the pointing device 130 is used to select a function of the MFP. In the illustrated embodiment, the LCD screen 120 displays the functions of the MFP. For example, the functions may include copying, emailing, faxing, printing, and scanning. A user can select one of the functions by moving the cursor 121 onto a desired function and pressing one of the stick buttons 132. In certain embodiments, the panel button 140 may be used instead of the stick buttons 132.

The pointing device 130 may also be used to scroll the screen 120. The illustrated screen 120 includes a scroll bar 122 on the right edge. A user can select a scroll function by moving the cursor 121 onto the scroll bar 122 and pressing the button 132. Then, the displayed image can be scrolled up or down by moving the pointing device in a desired direction. In certain embodiments, the displayed image may be diagonally scrolled by diagonally moving the pointing device 130.

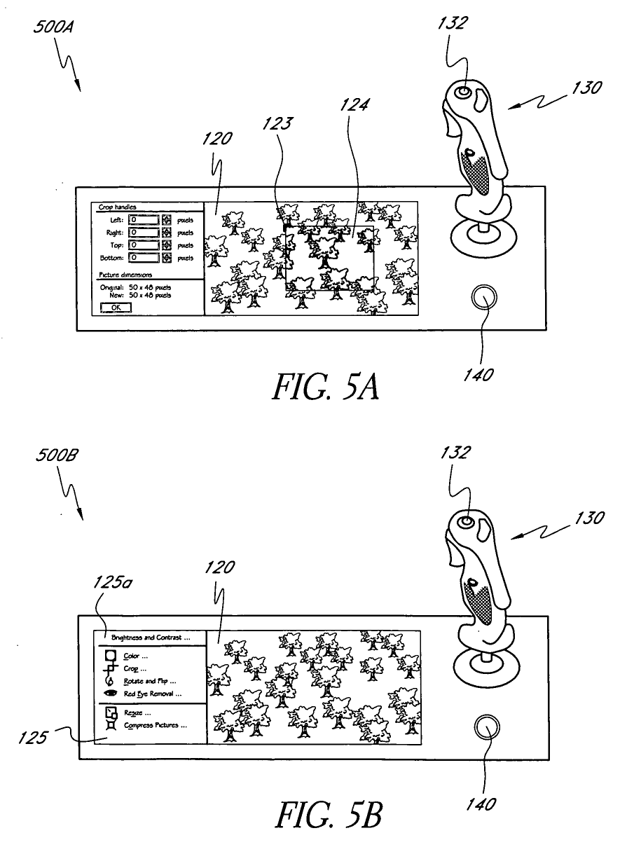

Referring to FIG. 5A, the pointing device 130 may be used for selecting a certain portion of an image on the screen 120. In the context of this document, a certain portion of an image may be referred to as a “target.”

In the illustrated embodiment, the pointing device 130 may be used to crop a target 124. In FIG. 5A, an image is displayed on the screen 120 for processing. First, a cropping function may be selected on a menu (not shown), using the pointing device 130 and the button 132. Then, a cropping cursor 123 is provided on the image. A user may move the cursor 123 to a desired point and then press the button 132 to select the point. Subsequently, the user may move the cursor 123 to another desired point and press the button 132 to select the other point. The two points constitute two diagonally opposite points of a rectangle. The rectangle represents the target to be processed. The target may be processed by at least one of the MFP functions. For example, the selected target may be copied, emailed, faxed, printed, and/or scanned. In selecting one or more of the functions, the user may also use the pointing device 130 and the button 132.

The pointing device may be used to adjust features and/or parameters of the MFP. Referring to FIG. 5B, for example, the pointing device 130 may be used to change a feature of an image on the screen 120. In the illustrated embodiment, brightness and contrast control is selected among other things. The user may select “brightness and contrast” 125a on a menu 125 on the screen 120, using the pointing device 130 and the button 132. Once the desired feature has been selected, the feature itself may also be adjusted, using the pointing device 130. For example, in adjusting the brightness of the image, moving the pointing device 130 right may increase the brightness. Moving the pointing device 130 left may decrease the brightness. A skilled artisan will appreciate that various other features may be adjusted using the pointing device.

In other embodiments, the pointing device 130 may be used to change parameters of the MFP. In one embodiment, in using the copying function of the MFP, a user may increment the number of copies, using the pointing device 130. For example, the user may select a “number of copies” icon on the screen 120, and then increment the number of copies by moving the pointing device up. Then, the desired number of copies may be selected by pressing the button 132. A skilled artisan will appreciate that various other parameters of the MFP may be adjusted using the pointing device.

The button 132 of the pointing device 130 may be used to reset parameters of the MFP. For example, in the above-described embodiment, the user may reset the number of copies to “1” by pressing the button 132 for a predetermined period of time, for example, 3 seconds.

In the embodiments described above, only certain functions and features of the MFP have been described. A skilled artisan, however, will appreciate that various other functions or features can be adapted for being carried out, using the pointing device.

The pointing devices described above may be provided to an MFP in various manners as will be described below. In FIGS. 2-4, the pointing devices are integral with the MFP. In certain embodiments, a pointing device may be externally connected to an MFP via a wired or wireless connection.

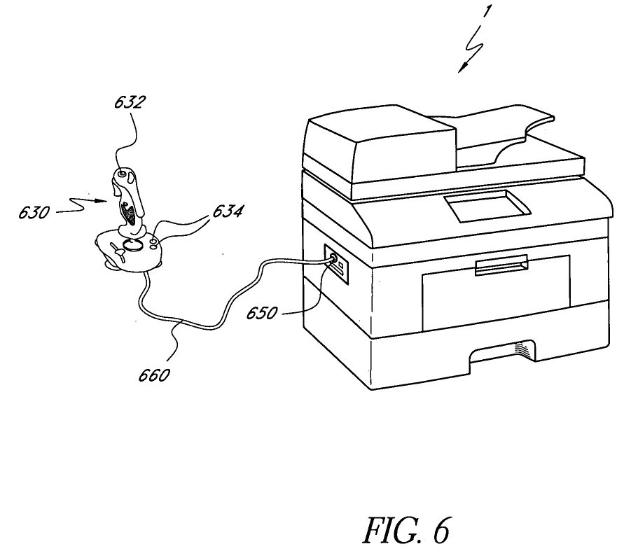

FIG. 6 illustrates one embodiment of an MFP 1 with an external pointing device 630. The illustrated pointing device 630 is a joystick with selection buttons 632 and 634. In other embodiments, the pointing device may be a trackball or D-pad. The pointing device 630 is electrically connected to the MFP 1 through a wire 660 via a port 650 of the MFP 1. The illustrated port 650 is a USB port. In certain embodiments, the port may be a serial or parallel port. The MFP 1 may include a suitable software program for interfacing with the pointing device 630. In another embodiment, the pointing device may have an embedded software program adaptable to various MFPs. In certain embodiments, the pointing device may be a plug-and-play device.

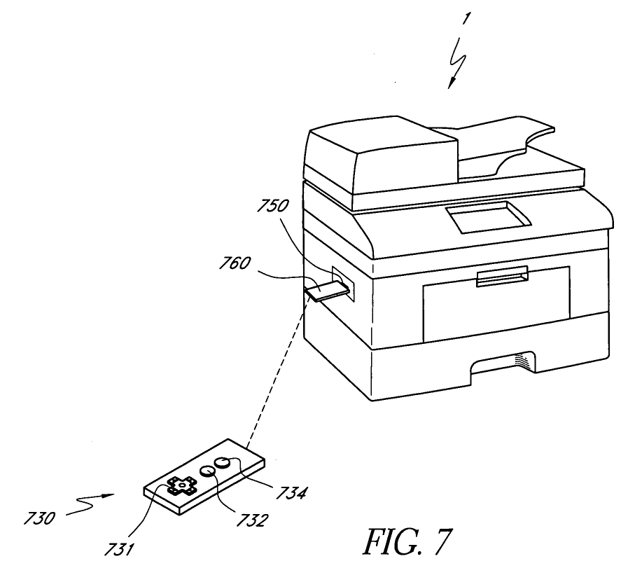

Referring to FIG. 7, a pointing device 730 is wirelessly connected to an MFP 1. The illustrated pointing device 730 includes a D-pad 731, selection buttons 732 and 734, and a wireless transmitter. The MFP 1 includes a wireless receiver 760. The illustrated wireless receiver 760 is externally plugged into a USB port 750 of the MFP 1. In other embodiments, the wireless receiver may be embedded in the MFP 1. The wireless transmitter and receiver provide a wireless connection between the MFP 1 and the pointing device 730. The wireless connection may be provided using any known wireless technology in the industry. Exemplary wireless technologies include, but are not limited to, radio frequency, infrared waves, wireless personal area network (PAN) (e.g., Bluetooth®), and wireless LAN (e.g., Wi-Fi).

The wirelessly connected pointing device operates as follows. The user may move the pointing device or press the selection button. The pointing device transforms the mechanical movement into an electrical signal representing the movement. Then, the pointing device transmits the signal to the MFP 1 according to a given wireless protocol. The MFP 1 receives the signal using the wireless receiver 760. The signal is transmitted to the processor of the MFP 1. The processor instructs the corresponding pointer movement on the screen. A skilled artisan will appreciate that various configurations of wireless operations may be adapted for use with the pointing device.

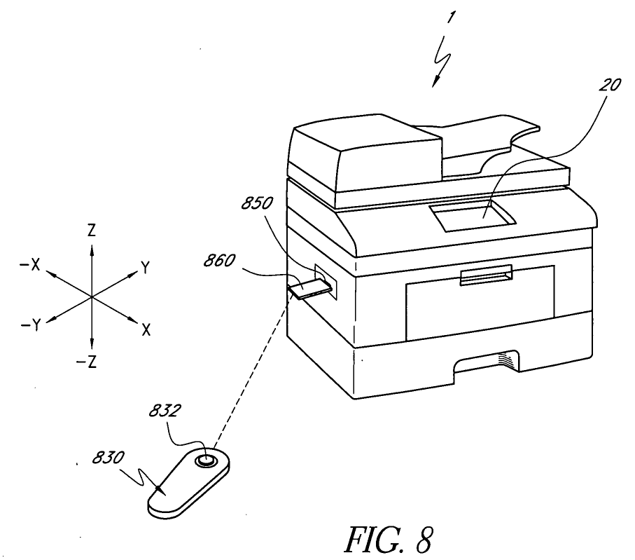

FIG. 8 illustrates another embodiment of an MFP 1 with an external pointing device 830. The illustrated pointing device 830 is configured to detect a three dimensional movement and to generate a signal corresponding to the three dimensional movement. For example, a user may move a cursor upward on the display screen 20 of the MFP 1 by moving the pointing device 830 in positive y-direction, as shown in FIG. 8. A user may also move the cursor right on the display screen 20 by moving the pointing device 830 in positive x-direction, as shown in FIG. 8.

In one embodiment, the pointing device 830 may be used for a zooming function of the MFP 1. The MFP 1 may display an image on the screen 20 for certain processing as described above with reference to FIGS. 5A and 5B. A user may zoom out the image by moving the pointing device 830 in positive z-direction. Alternatively, a user may zoom in the image by moving the pointing device 830 in negative z-direction. In certain embodiments, the pointing device may allow a user to zoom in or out a selected portion of the image. For example, a user may zoom in an upper right portion of the image by moving the pointing device at an angle of 45° from positive x-direction, positive y-direction, and negative z-direction. A skilled artisan will appreciate that the pointing device 830 may be used for other suitable functions of the MFP 1.

The pointing device 830 may include a motion sensor (not shown), a selection button 832, and a wireless transmitter (not shown). In one embodiment, the motion sensor includes a gyroscope. A gyroscope is a device for measuring orientation based on the principle of conservation of angular momentum. Details of a gyroscope are well-known in the industry. A skilled artisan will appreciate that the motion sensor may have various other configurations known in the industry. The selection button 832 and the wireless transmitter are as described above.

The illustrated pointing device 830 is wirelessly connected to the MFP 1. In other embodiments, the pointing device may have a wired connection with the MFP 1 as described above with reference to FIG. 6.

The pointing devices according to the embodiments described above provide a user with a simplified access to various functions of an MFP. The pointing devices allow the user to easily move a pointer on the MFP screen. In addition, the selection buttons add convenience to user-interfacing. Furthermore, the described pointing devices occupy only a small space on the MFP. In certain embodiments, the pointing devices can even be externally connected to the MFP, which requires virtually no space on the MFP.

The foregoing description is that of embodiments of the invention and various changes, modifications, combinations and sub-combinations may be made without departing from the spirit and scope of the invention, as defined by the appended claims.

What is claimed is:

1. A multi-function peripheral (MFP) device comprising:
a user interface comprising:
a pointing device configured to detect at least two dimensional mechanical movement provided by a user, and configured to generate a signal corresponding to the at least two dimensional mechanical movement; and
a display screen integral with the MFP device, the display screen comprising a pointer configured to move according to the signal.

2. The device of claim 1, wherein the pointer comprises a cursor.

3. The device of claim 1, wherein the at least two dimensional mechanical movement comprises a two dimensional movement in a direction at an angle between 0° and 360°.

4. The device of claim 3, wherein the two dimensional movement comprises a movement in a direction selected from: up, down, left, right, up-left, up-right, down-left, and down-right.

5. The device of claim 1, wherein the signal comprises data indicative of the direction of the at least two dimensional mechanical movement.

6. The device of claim 1, wherein the signal comprises data indicative of the distance of the at least two dimensional mechanical movement.

7. The device of claim 1, wherein the user interface further comprises one or more selection buttons.

8. The device of claim 1, wherein the pointing device comprises a joystick.

9. The device of claim 1, wherein the pointing device comprises a trackball.

10. The device of claim 1, wherein the pointing device comprises a directional pad (D-pad).

11. The device of claim 1, wherein the pointing device is configured to select a function of the MFP device.

12. The device of claim 1, wherein the pointing device is configured to scroll the display screen.

13. The device of claim 1, wherein the pointing device is configured to select a target on the display screen.

14. The device of claim 13, wherein the target comprises at least a portion of an image displayed on the display screen.

15. The device of claim 1, wherein the pointing device is configured to adjust a parameter of the MFP device.

16. The device of claim 1, wherein the pointing device is integral with the MFP device.

17. The device of claim 1, wherein the pointing device is wirelessly connected to the MFP device.

18. The device of claim 1, wherein the pointing device is electrically connected to the MFP device via a port.

19. The device of claim 18, wherein the port comprises a serial port, a parallel port, or a USB port.

20. The device of claim 1, wherein the at least two dimensional mechanical movement comprises a three dimensional movement.

21. The device of claim 20, wherein the pointing device comprises a motion sensor.

22. The device of claim 21, wherein the motion sensor comprises a gyroscope.

23. The device of claim 20, wherein the pointing device is configured to zoom in or out an image displayed on the display screen according to the three dimensional movement.

24. The device of claim 20, wherein the pointing device is connected to the MFP device wirelessly or via a port.

25. The device of claim 1, wherein the MFP device comprises two or more functions selected from: copying, faxing, scanning, printing, and emailing.

26. A multi-function peripheral (MFP) device comprising:
a display screen integral with the MFP device, the display screen comprising a pointer;
means for detecting at least two dimensional mechanical movement provided by a user;
means for generating a signal corresponding to the at least two dimensional mechanical movement; and
means for moving the pointer on the display screen according to the signal.

27. A method of user interfacing for a multi-function peripheral (MFP) device, the method comprising:
providing a display screen integral with the MFP device, the display screen comprising a pointer;
detecting at least two dimensional mechanical movement provided by a user;
generating a signal corresponding to the at least two dimensional mechanical movement; and
moving the pointer on the display screen according to the signal.

28. The method of claim 27, wherein the signal comprises data indicative of the direction of the at least two dimensional mechanical movement.

29. The method of claim 27, wherein the signal comprises data indicative of the distance of the at least two dimensional mechanical movement.

30. The method of claim 27, wherein the at least two dimensional mechanical movement comprises a two dimensional mechanical movement in a direction at an angle between 0° and 360°.

31. The method of claim 27, wherein the at least two dimensional mechanical movement comprises a three dimensional mechanical movement.
